(19) United States
(12) Patent Application Publication
(10) Pub. No.: US 2016/0292606 A1
(43) Pub. Date: Oct. 6, 2016

(54) OPTIMAL ALLOCATION OF HARDWARE INVENTORY PROCUREMENTS

(71) Applicant: MICROSOFT TECHNOLOGY LICENSING, LLC, Redmond, WA (US)

(72) Inventors: ARJUN MUKHERJEE, BELLEVUE, WA (US); AMOL BHALCHANDRA ADGAONKAR, REDMOND, WA (US)

(21) Appl. No.: 14/676,555

(22) Filed: Apr. 1, 2015

(51) Int. Cl. G06Q 10/06; G06Q 10/08; H04L 12/911

(52) U.S. Cl. CPC G06Q 10/06315; H04L 47/827; G06Q 10/087; G06Q 10/067

(57) ABSTRACT

In various embodiments, methods, computer-storage media, and systems for generating optimal allocation of hardware inventory procurements are provided. An adjusted total cost, based on assessment properties for hardware providers is determined. Assessment properties can be classified as assessment-property-metrics and assessment-property-data, where the assessment-property-metrics are computed using the assessment-property-data. At least two cost assessment-property-metrics that correspond to hardware providers of a hardware requestor having hardware inventory procurements, are identified to determine the adjusted total cost. Optimal allocation results of the hardware inventory procurement for the hardware providers are generated based on a total addressable market simulation, where the total address addressable market simulation indicates, based at least in part on the adjusted total cost and an exponential probability of loss cost, a total cost of ownership that includes exponential liability assumption of over-allocation. The optimal allocation results are communicated in tabular or graphical representations that indicate the optimal allocation solution.

### BACKGROUND

Cloud computing infrastructures may offer building, deployment and management functionality for different types of applications and services. In this regard, cloud computing infrastructures can require acquisition of large quantities hardware inventory for racks and clusters. Procuring hardware inventory can be based on several aspects of the hardware inventory supplied by a hardware provider, such as, price, quality, and performance differences across Original Equipment Manufacturers (OEM). Cloud computing infrastructure providers can frequently use several different hardware providers to meet hardware inventory procurements, with each hardware provider responsible for fulfilling an allocated amount of the hardware inventory procurement. Identifying an allocation amount of hardware inventory procurements for a cloud computing infrastructure can be limited when performed without accounting for appropriate information corresponding to a hardware provider and additional factors.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described herein methods, computer-storage media, and systems for generating optimal allocation of hardware inventory procurements. An adjusted total cost, based on assessment properties for hardware inventory provided is determined. Assessment properties can be classified as assessment-property-metrics and assessment-property-data, where the assessment-property-metrics are computed using the assessment-property-data. At least two cost assessment-property-metrics that correspond to hardware providers of a hardware requestor having a hardware inventory procurement are identified to determine the adjusted total cost. Optimal allocation results of the hardware inventory procurement for the hardware providers are generated based on a total addressable market simulation, where the total address addressable market simulation indicates, based on the adjusted total cost and an exponential probability of loss cost, a total cost of ownership that includes exponential liability assumption of over-allocation. The optimal allocation results are communicated in tabular or graphical representations that indicate the optimal allocation solution.

### BRIEF DESCRIPTION OF THE DRAWINGS

The present invention is described in detail below with reference to the attached drawing figures, wherein:

FIGS. 1A and 1B are block diagrams of an exemplary operating environment in which embodiments described herein may be employed;

FIGS. 2A and 2B are schematics of exemplary optimal allocation interface representations, in accordance with embodiments described herein;

FIG. 3 is a flow diagram showing an exemplary method for generating optimal allocation for hardware inventory procurements, in accordance with embodiments described herein;

FIG. 4 is a flow diagram showing an exemplary method for generating optimal allocation for hardware inventory procurements; and

FIG. 5 is a block diagram of an exemplary computing environment suitable for use in implementing embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion below, embodiments are described with reference to an optimal allocation generator platform associated with a cloud computing infrastructure; the optimal allocation generator platform can implement several components for performing the functionality of embodiments described herein. Components can be configured for performing novel aspects of embodiments, where configured for comprises programmed to perform particular tasks or implement particular abstract data types using code. It is contemplated that the methods and systems described herein can be performed in different types of operating environments having alternate configurations of the functional components. As such, the embodiments described herein are merely exemplary, and it is contemplated that the techniques may be extended to other implementation contexts.

An optimal allocation generator platform can be implemented on a cloud computing infrastructure that runs cloud applications and services across different data center and geographic regions. The cloud computing infrastructure can implement a fabric controller component for provisioning and managing resource allocation, deployment/upgrade, and management of cloud applications and services. Typically, a cloud computing infrastructure acts to store data or run applications and services in a distributed manner. The application and service components of the cloud computing infrastructure may include nodes (e.g., computing devices, processing units, or blades in a server rack) that are allocated to run one or more portions of applications and services.

When multiple applications and services are being supported by the nodes, the nodes may be partitioned into virtual machines or physical machines that concurrently run the separate service applications, respectively, in individualized computing environments that support the resources and/or operating system specific to each service application. Further, each application or service may be divided into functional portions such that each functional portion is able to run on a separate virtual machine. In cloud computing infrastructures, multiple servers may be used to run the applications and services to perform data storage operations in a cluster. In particular, the servers may perform data operations independently but exposed as a single device referred to as a cluster. Each server in the cluster may be referred to as a node.

Cloud computing infrastructures and other types of computing infrastructures can require acquisition of large quantities of hardware inventory in racks and clusters. Procuring hardware inventory can be based on several aspects of the hardware inventory supplied by a hardware provider, such as, price, quality, and performance differences across Original Equipment Manufacturers (OEM). Cloud computing infrastructure providers can frequently use several different hardware providers to meet hardware acquisition needs, with each hardware provider responsible for providing an allocated amount of the hardware inventory. Identifying an ideal allocation amount of hardware acquisition need for each OEM, for a cloud computing infrastructure can be limited when performed without accounting for assessment properties corresponding to a hardware provider and additional variable factors.

Embodiments described herein provide simple and efficient methods and systems for generating optimal allocation of hardware inventory procurements for a computing infrastructure (e.g., cloud computing infrastructure) based on an optimal allocation generator platform. Hardware inventory or hardware inventory components, as used herein interchangeably, can refer to physical devices, parts or components of a computing device, including blades, servers, servers in racks, groups of racks in clusters, and networking devices. The optimal allocation generator platform refers to a plurality of optimal allocation generator components that facilitate identifying an optimal allocation of hardware inventory procurements to hardware providers. In particular, optimal allocation of hardware inventory procurements can be generated using a simulation that runs a Total Addressable Market (TAM) model to generate an optimal allocation based on total cost ownership that comprises an adjusted total cost and exponential probability of loss (PoL). For example, the optimal allocation of hardware inventory procurements accounts for real cost and opportunity cost as indicators of total cost of ownership, as measured in the adjusted cost. Further, advantageously, the optimal allocation reduces the potential downsides of over-allocating to one or more hardware providers, in that, the total cost of ownership factors the exponential liability assumption of over-allocation, as measured in the exponential probability of loss. The optimal allocation generated can indicate an allocation of the hardware inventory procurements of a cloud computing infrastructure provider across multiple hardware providers. The optimal allocation indicates the split of hardware inventory procurements between hardware providers.

In operation, assessment properties for determining optimal allocation of hardware inventory procurements can be accessed. Assessment properties can be based in part on hardware provider of hardware inventory in a cloud computing infrastructure. Assessment properties can be data from a plurality of data sources including OEM quotes for hardware inventory, historical on time delivery data, engineering or quality data, and data center operations data. Assessment properties can be automatically generated and accessed from a plurality of data sources.

Assessment properties can further include metrics generated from the data from the plurality of data sources. Metrics can include hardware inventory costs, supply delays, number of return merchandise authorizations, and return merchandise authorization delays, and OEM validation delays. The rack costs and supply delays can define a cost penalty and an opportunity cost metric as a proxy of lost revenue. The cost penalty and opportunity cost can define an adjusted cost that is accessed in defining an optimal allocation for hardware inventory procurements.

Generating the optimal allocation further includes identifying a probability of loss (PoL) of supply factor for a perceived market supply disruption based on the mean time between failures in supply. Failures can specifically refer to catastrophic failures. Additional factors can include weights or scalars that can be defined to scale the optimal allocation generator platform and weight certain factors more than others. The optimal allocation can be generated and communicated using an allocation interface. The allocation interface can include an allocation of a set of recommendations in a menu of choices, a range of allocation options, and various sensitivity graphs generated using a simulation based on a TAM model.

The functionality of the optimal allocation generator platform can be performed using optimal allocation generator platform components. The optimal allocation generator platform components refer to the hardware architecture and software framework that support defining and measuring particular assessment properties utilized in the optimal allocation generator platform. The hardware architecture refers to physical components and interrelationships thereof and the software framework refers to software providing functionality that can be implemented with hardware for identifying the optimal allocation of hardware inventory procurements. In particular, the software framework can be executed on an optimal allocation generator device to operate computer hardware to provide optimal allocation generator functionality, such as, a simulator that runs a Total Addressable Market (TAM) model. By way of example, the optimal allocation generator platform can include an API library that includes specifications for routines, data structures, object classes, and variables may support the interaction the hardware architecture of the device and the software framework. These APIs include configuration specifications for the optimal allocation generator platform to support optimal allocation. In embodiments, the optimal allocation generation platform can implement an optimal allocation interface that indicates the optimal allocation of hardware inventory procurements. The optimal allocation interface supports interaction with assessment properties and variables of the TAM model for running simulations with different assessment properties and variables to generate different results.

Accordingly, in a first embodiment described herein, a system for generating optimal allocation of hardware inventory procurements is provided. The system includes an assessment-property component configured for: accessing assessment-property-data for a cloud computing infrastructure, the assessment-property-data is identified based in part on hardware providers associated with a hardware inventory procurement; generating assessment-property-metrics, where assessment-property-metrics comprise calculated assessment metrics for the hardware providers, based on corresponding assessment-property-data; and communicating a cost assessment-property-metric corresponding to each of the hardware providers.

The system also includes a simulation component configured for: determining an adjusted total cost based on the cost assessment-property-metric; generating optimal allocation results of the hardware inventory procurement for the hardware providers based on a total addressable market simulation, where the total address addressable market simulation indicates, based on the adjusted total cost and an exponential probability of loss cost, a total cost of ownership that includes exponential liability assumption of over-allocation; and communicating the optimal allocation results. The system further includes an optimal allocation interface component configured for: accessing optimal allocation results that correspond to the hardware providers; and communicating the optimal allocation results for display, where the optimal allocation results include at least one of an optimal allocation indicator, a menu of choices, and a sensitivity graph.

In a second embodiment described herein, one or more computer storage media having computer-executable instructions embodied thereon that, when executed, by one or more processors, causes the one or more processors to perform a method for generating optimal allocation of hardware inventory procurements is provided. The method includes determining an adjusted total cost based on a plurality of cost assessment-property-metrics, where the plurality of cost assessment-property-metrics correspond to hardware providers of a hardware requestor having a hardware inventory procurement. The method also includes generating optimal allocation results of the hardware inventory procurement for the hardware providers based on a total addressable market simulation, where the total addressable market simulation indicates, based on the adjusted total cost and an exponential probability of loss cost, a total cost of ownership that includes exponential liability assumption of over-allocation. The method further includes communicating the optimal allocation results.

In a third embodiment described herein, a computer-implemented method for generating optimal allocation of hardware inventory procurements is provided. The method includes accessing optimal allocation results that correspond to hardware providers for a hardware requestor having a hardware inventory procurement, where the optimal allocation results are based on a total addressable market simulation, where the total address addressable market simulation indicates, based on the adjusted total cost and an exponential probability of loss cost, a total cost of ownership that includes exponential liability assumption of over-allocation. The method also includes communicating the optimal allocation results for display, where the display comprises at least two of an optimal allocation indicator, a menu of choices, and a sensitivity graph.

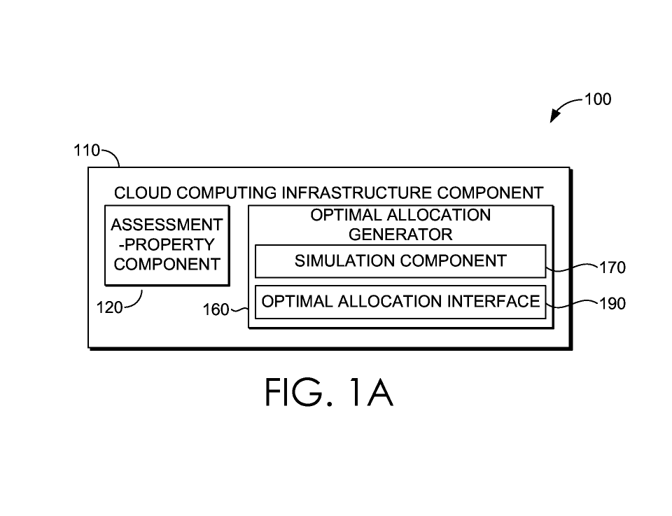

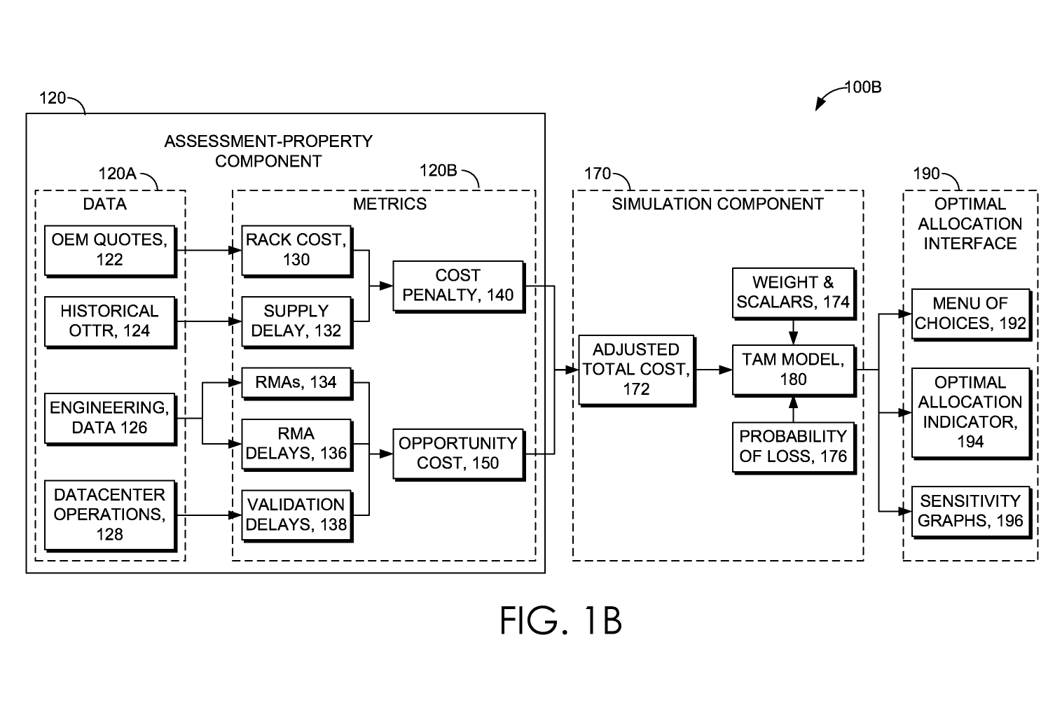

Referring now to FIG. 1A, FIG. 1A illustrates an exemplary optimal allocation generator platform system 100 in which implementations of the present disclosure may be employed. In particular, FIG. 1A shows a high level architecture of optimal allocation generator platform system. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Optimal allocation generator platform system 100 can be implemented to determine an optimal allocation of hardware inventory procurements. Optimal allocation generator platform system can include a computing platform with components (e.g., a hardware architecture and software framework) that facilitate generating optimal allocation. Optimal allocation comprises allocation of hardware inventory procurements to a plurality of hardware providers based on variables associated with the hardware providers. Specifically, the distribution can be based on all the hardware providers (i.e., total addressable market) that are capable of fulfilling the hardware inventory procurement. The allocation can be for eventual procurement of the hardware inventory procurements from the hardware providers based at least in part on the optimal allocation.

Hardware inventory procurements can be for specific hardware inventory components (e.g., HARDWARE_A, HARDWARE_B, and HARDWARE_C) that can be procured from a plurality of hardware providers to meet hardware inventory procurements in a computing infrastructure. In one embodiment, procurements needs may specifically refer to a cluster comprising a group of racks, where each rack is made up of multiple servers with individual hardware components (e.g., memory and processors). As such, if multiple hardware providers can supply a particular hardware component at different quoted prices, then embodiments described herein can be performed for specific scenarios with each hardware component at a selected quoted price for a hardware provider. It is contemplated that OEMs can by hardware components during an assembly process and quote prices to a computing infrastructure provider based on a hardware component vendor sheet selected.

The hardware inventory procurement can be for a cloud computing infrastructure. It is contemplated that the cloud computing infrastructure can also be responsible for implementing the optimal allocation generator platform system 100. Hardware inventory procurements can be allocated for hardware providers that are associated with several variables that are factored in to a total market allocation model, as described herein. The TAM model uses the variables to determine the optimal allocation of the hardware inventory procurements.

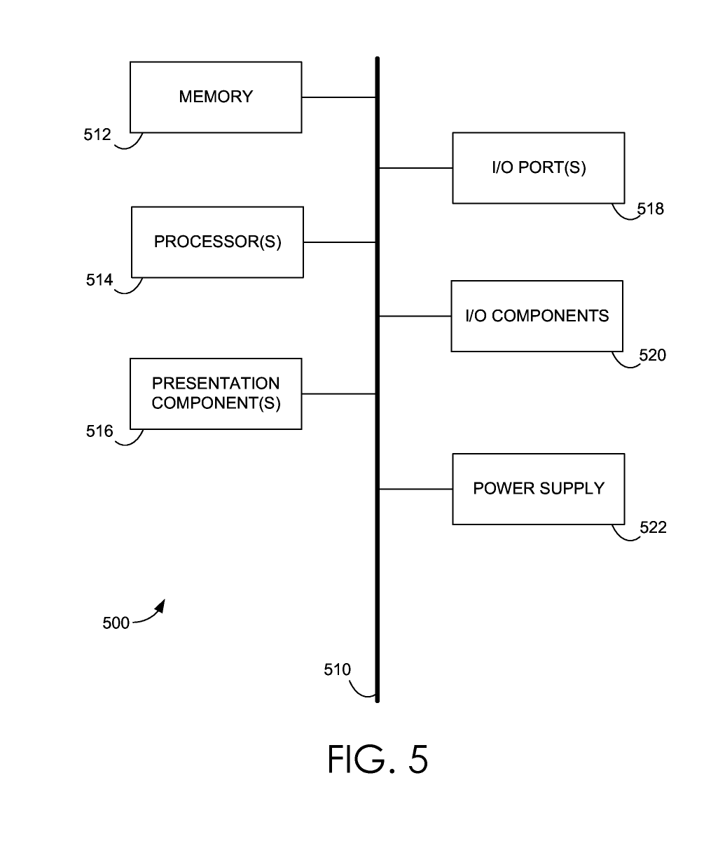

Among other components not shown, optimal allocation generator platform system 100 includes a cloud computing infrastructure 110 having an assessment-property component 120 and an optimal allocation generator device 160 having a simulation component 170 and an optimal allocation interface component 190. The cloud computing infrastructure 110 can support hardware inventory that includes different types of computing devices, each computing device resides on any type of computing device, which may correspond to computing device 500 described with reference to FIG. 5, for example. The components of the optimal allocation generator platform system 100 may communicate with each other over a network, which may include, without limitation, one or more local area networks (LANs) and/or wide area networks (WANs). Any number of nodes (e.g., servers) and client computing devices may be employed within the optimal allocation generator platform system 100 within the scope of implementations of the present disclosure.

The optimal allocation generator platform system 100 may be supported by the cloud computing infrastructure 110 for which the optimal allocation of hardware inventory is being generated for. For example, the cloud computing infrastructure can implement components of the optimal allocator generator platform system 100 as a service in the cloud computing infrastructure 110. It is contemplated that components of the optimal allocation generator platform system 100 can also be implemented independently of the cloud computing infrastructure 110. The cloud computing infrastructure 110 can include racks and clusters that define nodes that are utilized to store and provide access to data in the storage and compute of cloud computing infrastructure. The cloud computing infrastructure 110 may be a public cloud, a private cloud, or a dedicated cloud. The cloud computing infrastructure 110 may include a datacenter configured to host and support operation of endpoints in a particular application or service. The phrase “application” or “service” as used herein broadly refers to any software, or portions of software, that run on top of, or accesses storage and compute devices locations within, a datacenter.

Having described various aspects of the optimal allocation generator platform system 100, it is noted that any number of components may be employed to achieve the desired functionality within the scope of the present disclosure. Although the various components of FIG. 1A are shown with lines for the sake of clarity, in reality, delineating various components is not so clear, and metaphorically, the lines may more accurately be grey or fuzzy. Further, although some components of FIG. 1A are depicted as single components, the depictions are exemplary in nature and in number and are not to be construed as limiting for all implementations of the present disclosure.

With reference to FIG. 1B, FIG. 1B includes the optimal allocation generator framework 100B of the optimal allocation generator platform system 100. The optimal allocation generation framework 100B and functionality supported therein can be described by way of an exemplary operating environment. The optimal allocation generation framework 100B can include the assessment-property component 110, the optimal allocation generator 160 having the simulation component 170 and the optimal allocation interface component 190. Each component comprises additional components that support functionality thereof as described herein. Each component can implement portions of an optimal allocation generator platform system 100A to support functionality of the optimal allocation generator platform system 100A.

The assessment-property component 120 is responsible for managing and providing access to assessment properties. Assessment properties may generally refer to quantified attributes or operations associated with a hardware provider (e.g., PROVIDER_A, PROVIDER_B, or PROVIDER_C). As such, assessment properties can be based in part on a hardware inventory of hardware providers for a cloud computing infrastructure. Assessment properties can be retrieved from a plurality of different sources, such as, databases that store the information, and applications and services that process the data. In one embodiment, a cloud computing service may support gathering the assessment dimensions information for a cloud computing infrastructure and communicating the information to the assessment dimension component 110. Assessment properties can include assessment-property-data and assessment-property-metric. In this regard, the assessment property component can manage the assessment properties by retrieving, storing, processing, and communicating the assessment properties in part based on their classification.

Assessment-property-data 120A and assessment-property-metrics 120B can refer to classifications of assessment properties. Assessment-property-data 120B may be derived and retrieved from attributes of a hardware provider or actions performed in a cloud computing infrastructure based on attributes of the hardware provider. Assessment-property-metrics 120A can be generated from two or more assessment-property-data. Actions can be performed by the hardware providers and/or operators in the cloud computing infrastructure.

Assessment-property-data 120A can be data from a plurality of data sources including OEM quotes 122 for hardware inventory. A quote comprises a stated price or current price for a particular hardware component from the corresponding OEM. Assessment-property data can also include historical on time delivery data—historical OTTR 124 (historical on time to request). In one embodiment, OTTR indicates a percentage of parts that are delivered on time to the request the requested date of a corresponding purchase order. It is also contemplated that OTTR is a measure of variation from the delivery date (i.e., an actual delivery data compared to the requested delivery date). The variation on the delivery date can specifically be used to estimate the average and standard deviation of the supply delay.

Assessment-property-data 120A further include engineering data 126 that indicate a quality rating for a specific hardware inventory. The hardware quality data provides an estimated capacity that is unavailable for use, in this regard, the hardware quality data can comprise a percentage of sellable capacity that is not available for deployment. In embodiment, the engineering data may alternatively, by way of example, be based on historical rate of failure of the specific hardware inventory component, which is then associated with a rating. Individual hardware inventory components can automatically receive engineering ratings as the hardware inventory fails or continues to provide functionality without failure. For example, a cloud computing infrastructure service may detect failure of hardware components and automatically update engineering data for hardware providers associated with the failed hardware inventory, such that, this information is readily incorporated into the optimal allocation generator framework for processing. Other variations and combinations of detecting hardware component failures and updating the engineering data for a corresponding hardware provider are contemplated with embodiments described herein.

Assessment-property-data 120A also includes datacenter operations data 128 that indicate processes in datacenter operations that are associated with a particular hardware component. For example, a hardware component from a first hardware provider may not need additional configuration upon initial bootstrapping into the datacenter, while a second hardware inventory needs additional configuration. It is contemplated that an OEM can be responsible for a basic validation process before the datacenter operations, the basic validation process can include validation of hardware inventory shipment for a predefined period of time. Individual operations performed in the datacenter associated with hardware inventory can be quantified and factored as assessment-property-data. Identification of a datacenter operation can also be monitored by a service in the cloud computing infrastructure. For example, upon bootstrapping a rack into a datacenter, the service may identify hardware components that trigger additional datacenter operations and track the datacenter operations for a corresponding hardware inventory component and hardware provider pair. Assessment-property-data 120A described herein are meant to be exemplary and not limiting to embodiments described herein, as such, other variations and combinations of assessment properties are contemplated.

The assessment-property component 120 is further responsible for generating assessment-property-metrics 120B. Assessment-property-metrics 120B can be computed based on assessment-property-data 120A and other assessment-property-metrics 120B. Assessment-property-metrics 120B can also correspond to individual hardware providers. As shown in FIG. 1B, the OEM quotes 122 define rack cost 130. For example, individual OEM quotes 122 for a hardware component can be utilized to determine the cost of those hardware components when implemented at a rack level. The use of rack is merely exemplary, other hardware inventory individual and combination components are contemplated in the present disclosure. The historical OTTR 124 can define supply delay 132, such that, the rack cost 130 and supply delay 132 can be used to calculate a cost penalty 140 for a corresponding hardware provider when relied upon to provide the hardware inventory component. The supply delay can be hedged against by the use of an inventory of finished goods in a warehouse. The cost of warehousing can specifically be considered in the incremental cost penalty. The cost penalty can generally refer to a real cost that incorporates the quoted cost (e.g., rack cost) as modified by a timeliness of delivery (e.g., supply delay) as computed for particular hardware provider for a hardware inventory component. It is contemplated that the additional cost added by the supply delay can also be singled out of any additional processing.

Additionally, the engineering data 126 may be processed by an RMA service (not shown) that receives identification of a hardware inventory component, hardware provider, and the corresponding return merchandise authorization (RMA 134) based on the engineering data that included failed hardware inventory components. The RMA service can track the RMA 134 to determine RMA delays 136. For example, the RMA 134 can be associated with an expected due date for returning a replacement or refurbished hardware inventory component; however if the hardware inventory component is not returned on the expected due date, the RMA service can update the RMA delays 136 for the corresponding hardware inventory.

Datacenter operations 128 define validations delays 138. The datacenter operations 128 can be triggered based on assessment property component 120 automatically receiving communications from the cloud computing infrastructure of datacenter operations that could not be completed. For example, incorrectly configured hardware inventory components (e.g., rack wiring, firmware, and incorrect hardware locations, or missing hardware) can delay a bootstrapping process that incorporates a new rack into a datacenter. As such, the bootstrapping operation cannot be completed, leading to validation delays of hardware inventory components.

The RMAs 134, RMA delays 136, and validation delays 138 can be used to generate an opportunity cost for the corresponding hardware provider. Opportunity cost can generally indicate the lost revenue or amount given up by selecting the corresponding hardware provider to fulfill the hardware inventory procurement. The assessment component 120 can be configured to communicate the assessment-property-metrics to the simulation component for additional processing in defining an optimal allocation for hardware inventory procurements.

As shown below in TABLE A, various assessment-property-metrics based on assessment-property-data can be associated with a hardware provider (e.g., PROVIDER_A and PROVIDER_B). It is contemplated that a hardware provider can be evaluated based on a specific hardware inventory component or on plurality of hardware inventory components.

TABLE A

| Assessment-Property | PROVIDER_A | PROVIDER_B |
|---|---|---|
| RMAs Per Cluster Per Month | 15.667 | 15.667 |
| Average Delay per RMA (in Days) | 11.35 | 10.99 |
| Average Supply Delays (in Days) | 9.25 | 14 |
| Standard Deviation of Supply Delays | 6.04 | 3.74 |
| OEM Validation Delays | 18.57 | 11 |
| Supply disruption chances (Once in) | 50 years | 50 years |

With reference to FIG. 1A, the optimal allocation generator 160 may be a computing device, as described herein, or a component, that implements one or more components of the optimal allocation platform. In particular, the optimal allocation generator 160 can include the simulation component 170 that generates optimal allocation (e.g., optimal allocation results). The optimal allocation generator 160 can be implemented as a standalone device or as part of a cloud computing infrastructure. The optimal allocation generator 160 communicates with an optimal allocation interface component 190 to provide the optimal allocation results generated at the simulation component 170.

Turning to FIG. 1B, the simulation component 170 is responsible for generating the optimal allocation of hardware inventory procurement based on the total addressable market (TAM) model 180. In particular, the simulation component 170 executes the model that incorporates variables that correspond to the hardware providers. Functionally, the model represents key assessment properties used to calculate a menu of choices for the optimal allocation of hardware inventory procurements. The total addressable market can refer to the hardware providers available or considered by a hardware requestor for a hardware inventory procurement. The TAM model helps distribute a hardware inventory procurement fulfillment to individual hardware providers in a set of hardware providers.

The simulation component 170 can implement the TAM model having a plurality of variables. The inclusion of variables, such as, an adjusted total cost 172, weights and scalars 174, and the probability of loss 176 modify the allocation of the hardware inventory procurement based on determined values of the variables. These variables act as factors in the determination of optimal allocation results. Optimal allocation results can be based on a total addressable market simulation comprising at least an adjusted total cost factor and an exponential probability of loss, and optionally weighted factors, of each of the hardware providers that fulfill the hardware inventory component for the hardware requestor.

The adjusted total cost 172 may be generated based on the cost penalty and the opportunity cost assessment-property-metrics. By way of example, TABLE shows the assessment property information combined to generate adjusted total cost per rack for hardware providers (PROVIDER_A and PROVIDER_B).

TABLE B

| Adjusted Total Cost Per Rack | PROVIDER_A | PROVIDER_B |
|---|---|---|
| (HARDWARE_A) | $334,670 | $297,662 |
| (HARDWARE_B) | $297,090 | $282,963 |
| (HARDWARE_C) | $302,782 | $285,119 |

The weight and scalars 172 can be optionally defined to scale the simulation and weight certain factors more than others. A probability of loss of supply due to a supply disruption can also be provided, where the probability of loss can be calculated based on the mean time between failure of supply for a hardware provider. Other variations and combination of probability of loss, weights and scalars, and supply disruption are contemplated with embodiments of the present invention.

The simulation component 170 can implement the TAM model as an algorithm and equation to generate the optimal allocation result for a hardware inventory procurement. The use of rack is merely exemplary and is not meant to be limiting, it is contemplated that different types of hardware inventory and hardware inventory components can be implemented as part of the TAM model. The TAM model can include one or more of the following variables defined as shown below:

C_{RACK}=Quoted rack price by OEMs
C_{RMA}=Cost of RMAs per rack
C_{SUP}=Cost of Supply delays per rack
C_{VAL}=Cost of Validation delays per rack
Total Adjusted Cost per rack:

C_{ADJ}=C_{RACK}+C_{RMA}+C_{SUP}+C_{VAL}

Q_{PROVIDER}_{_}_{A}=Rack award to PROVIDER_A
Q_{PROVIDER}_{_}_{B}=Rack award to PROVIDER_B

The model defines the Penalty functions as absolute difference and a normalized difference as shown

below:

ABS(Diff)=ABS(Q_{PROVIDER}_{_}_{A}−Q_{PROVIDER}_{_}_{B})

Norm(Diff)=ABS(Diff)/(Q_{PROVIDER}_{_}_{A}+Q_{PROVIDER}_{_}_{B})

Total Purchase Order Cost=PROVIDER_A C_{RACK}*Q_{PROVIDER}_{_}_{A}+PROVIDER_BC_{RACK}*Q_{PROVIDER}_{_}_{B}

R_{RACK}=Revenue per rack for a defined time period

### λ=Coefficient of Probability of Loss Aversion

P %=Probability of supply disruption

Exponential Probability of Loss Function E(x)=e^{λ*Norm(Diff)}

The total PO cost, total cost, and the Exponential Probability of Loss costs are computed as:

Exponential Probability of Loss Cost C_{ER}=R_{RACK}*ABS(Diff)*E(x)*P %

Total Cost Including Probability of Loss C_{TOTAL}=C_{ADJ}+C_{ER}

The TAM model can be used to generate optimal allocation results which can be presented in several different ways.

The optimal allocation interface 190 is responsible for communicating optimal allocation results. The optimal allocation generator interface 190 can refer to the capacity for the optimal allocation generator platform to communicate and receive information to a user. The optimal allocation interface 190 can, in one embodiment be, a point of interaction with the optimal allocation generator platform. For example, a hardware requestor using the optimal generator platform may enter and/or alter different variables and directly control functionality of the optimal generator platform with manual overrides. Further, the optimal allocation interface can indicate a menu of choices 192, the optimal allocation indicator, and sensitivity graphs in one or more different interfaces.

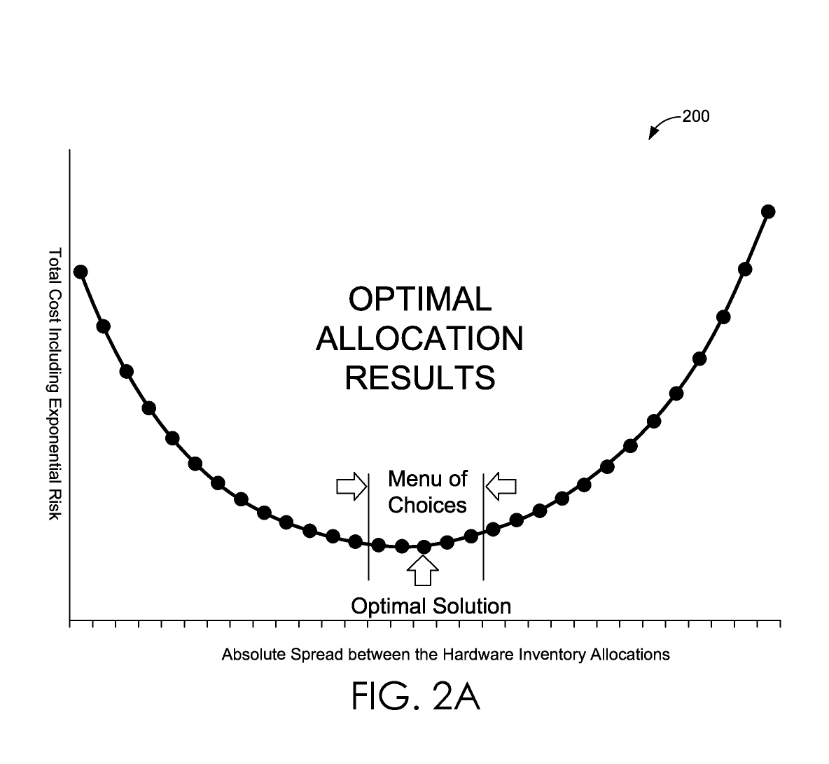

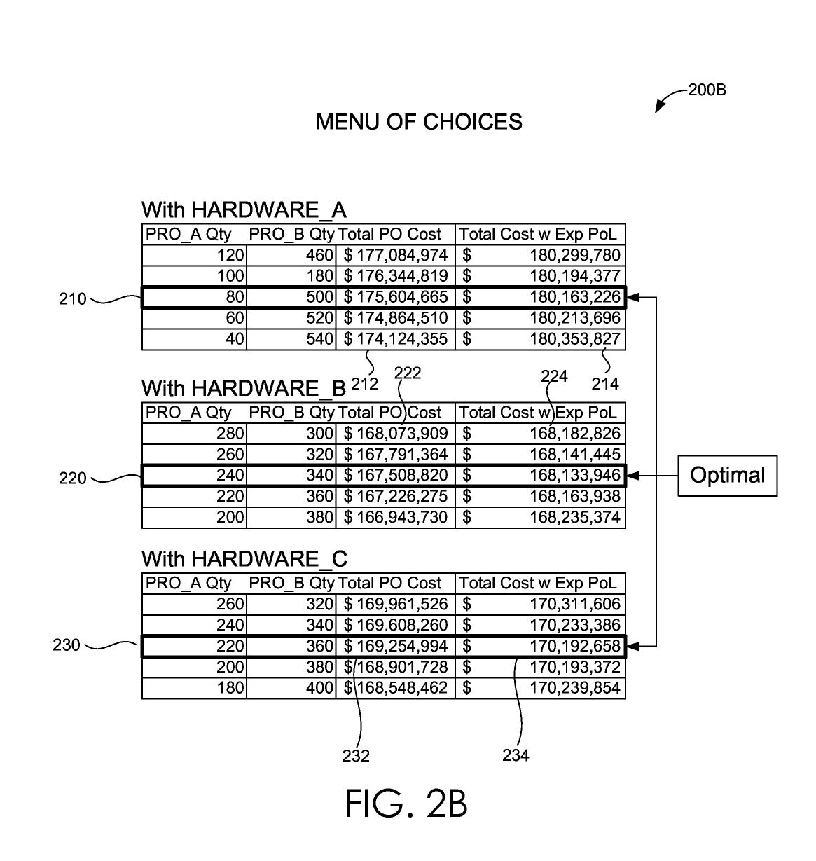

With reference to FIG. 2A, a sensitivity graph is generated based on the optimal allocation results. The convex function of the TAM model can be graphically represented where the function is optimized for the lowest cost, which corresponds to the optimal allocation (e.g., optimal solution). A menu of choices can be explicitly identified with the optimal allocation highlighted with an optimal allocation indicator. The menu of choices can be based on a predetermined range of acceptable alternate optimal allocation solutions. The menu of choice can be referenced for review, in that, the menu of choices allow for override in the optimal solution; a hardware requestor can deviate from the lowest total cost for external or intangible benefits not captured in the model based on making additional investments beyond the lowest total cost. TABLE C demonstrates a distribution of racks for a total TAM of 580 racks.

TABLE C

| Allocation with | PROVIDER_A | PROVIDER_B |
|---|---|---|
| HARDWARE_A | 80 | 500 |
| HARDWARE_B | 240 | 340 |
| HARDWARE_C | 220 | 360 |

With reference to FIG. 2B, FIG. 2B shows an exemplary tabular representation of the menu of choices. It is contemplated that the different interface elements can be displayed in combination or displayed individually but linked with each other for user friendly navigation. HARDWARE_A, HARDWARE_B, and HARDWARE_C each include the lowest total cost including the exponential probability of loss (PoL) highlighted respectively, as the optimal allocation 210, 220 230.

Optimal solution 210 includes a total PO cost 212 which is higher than other total PO costs but the optimal solution 210 corresponds to the lowest total cost with Exp—PoL 214. Alternatively, a hardware inventory request can make an additional investment and deviate from optimal allocation 220 and use the total PO cost 222 and the total cost—PoL 224 instead because additional factors may drive the hardware requestor to select a near even split (e.g., 280 and 300 instead of 240 and 340) to the hardware inventory. Optimal allocation 230 indicates an exemplary optimal allocation result where the lowest total PO cost (i.e., total PO cost 232) corresponds to the lowest total cost—PoL (i.e., total cost—POL 234). Other variations and combinations of tabular representation of optimal allocation results are contemplated with the present disclosure. In this regard, the optimal allocation interface advantageously provides optimal allocation results in a manner that improves productivity in that several different options for hardware procurement and combinations thereof are immediately available for analysis and decision-making purposes.

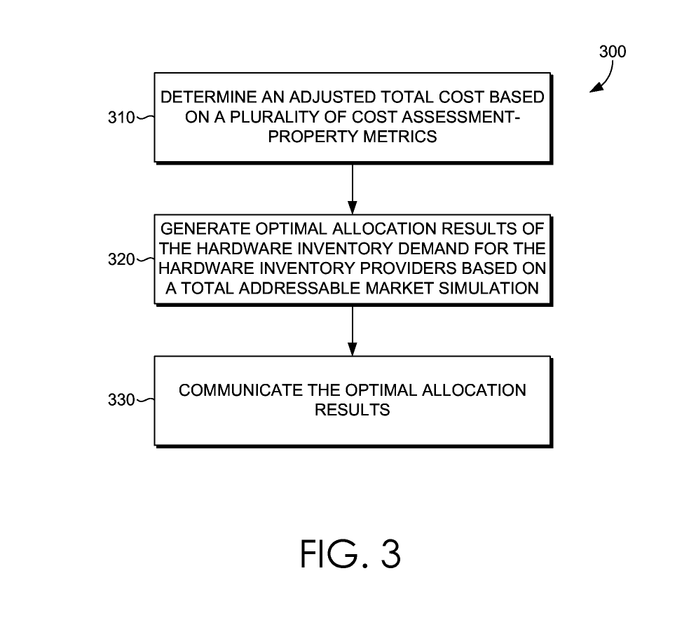

Turning now to FIG. 3, a flow diagram is provided that illustrates a method 300 for generating optimal allocation of hardware inventory procurements. At block 310, an adjusted total cost is determined based on a plurality of cost assessment-property-metrics. The plurality of cost assessment-property-metrics correspond to hardware providers of a hardware requestor having a hardware inventory procurement. The adjusted total cost is determined based on assessment-property-metrics, where an assessment-property-metric comprises a classification of an assessment property of a hardware provider, the assessment-property-metric computed based on assessment-property-data. The assessment-property-data is a classification that represents actions performed in a computing infrastructure based on attributes of the hardware provider. The hardware requestor may operate a cloud computing infrastructure that includes a service that facilitates automatically retrieving, storing, processing, and communicating assessment-property-data and computing assessment-property metrics.

At block 320, optimal allocation results of the hardware inventory procurement for the hardware providers is generated based on a total addressable market simulation. The total addressable market simulation indicates, based on the adjusted total cost and an exponential probability of loss cost, a total cost of ownership that includes exponential liability assumption of over-allocation. At block 330, the optimal allocation results are communicated.

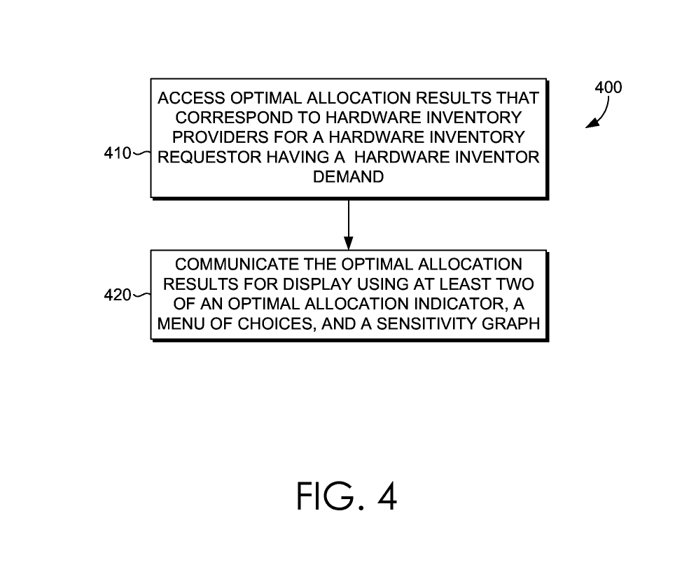

Turning now to FIG. 4, a flow diagram is provided that illustrates a method 400 for generating optimal allocation of hardware inventory procurements. Initially at block 410 optimal allocation results that correspond to hardware providers for a hardware requestor having a hardware inventory procurement are accessed. The optimal allocation results are based on a total addressable market simulation, where the total address addressable market simulation indicates, based on the adjusted total cost and an exponential probability of loss cost, a total cost of ownership that includes exponential liability assumption of over-allocation. At block 420, the optimal allocation results are communicated for display, where the display comprises at least two of: an optimal allocation indicator, a menu of choices, and a sensitivity graph.

By way of example, the optimal allocation can be indicated using an optimal allocation indicator in a menu of choices, where the optimal allocation results are generated in at least one of a graph representation or a tabular representation. The tabular representation can include a total purchase order cost and a total cost of ownership. The total cost of ownership is based on the adjusted total cost and the exponential probability of loss cost, where the exponential probability of loss cost is based on a revenue of the hardware inventory for a defined time period, an absolute difference penalty function based on hardware inventory awards to hardware providers, an exponential probability of loss function and a probability of supply disruption.

Having briefly described an overview of embodiments of the present invention, an exemplary operating environment in which embodiments of the present invention may be implemented is described below in order to provide a general context for various aspects of the present invention. Referring initially to FIG. 5 in particular, an exemplary operating environment for implementing embodiments of the present invention is shown and designated generally as computing device 500. Computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 5, computing device 500 includes a bus 510 that directly or indirectly couples the following devices: memory 512, one or more processors 514, one or more presentation components 516, input/output ports 518, input/output components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 5 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc.

Embodiments presented herein have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A system for generating optimal allocation of hardware inventory procurements, the system comprising:
an assessment-property component configured for:
accessing assessment-property-data for a cloud computing infrastructure, wherein the assessment-property-data is identified based in part on hardware providers associated with a hardware inventory procurement;
generating assessment-property-metrics, wherein assessment-property-metrics comprise calculated assessment metrics for the hardware providers, based on corresponding assessment-property-data; and
communicating a cost assessment-property-metric corresponding to each of the hardware providers;
a simulation component configured for:
determining an adjusted total cost based on the cost assessment-property-metric;
generating optimal allocation results of the hardware inventory procurement for the hardware providers based on a total addressable market simulation, wherein the total address addressable market simulation indicates, based on the adjusted total cost and an exponential probability of loss cost, a total cost of ownership that includes exponential liability assumption of over-allocation;
communicating the optimal allocation results;
an optimal allocation interface component configured for:
accessing optimal allocation results that correspond to the hardware providers; and
communicating the optimal allocation results for display, wherein the optimal allocation results include at least one of: an optimal allocation indicator, a menu of choices, and a sensitivity graph.

2. The system of claim 1, wherein the hardware inventory procurement is for a hardware inventory component where the hardware providers represent the total addressable market that comprises each of the hardware providers that fulfill the hardware inventory component for a hardware requestor.

3. The system of claim 2, wherein the cloud computing infrastructure implements an at least one of: the assessment-property component, the simulation component, and the optimal allocation interface component as a service supported using the cloud computing infrastructure of the hardware requestor.

4. The system of claim 1, wherein the assessment-property component accesses the assessment-property-data and computes assessment-property-metrics based on implementing a service in the cloud computing infrastructure, wherein the service automatically retrieves, stores, processes, and communicates the assessment-property-data and computes assessment-property metrics based at least in part on a corresponding classification.

5. The system of claim 1, wherein the adjusted cost is based on a cost penalty and opportunity cost estimated on account of the hardware providers.

6. The system of claim 1, wherein the exponential probability of loss cost is based on a revenue of the hardware inventory for a defined time period, an absolute difference penalty function based on hardware inventory awards to hardware providers, an exponential probability of loss function and a probability of supply disruption.

7. The system of claim 6, wherein the exponential probability of loss function comprises a coefficient of probability of loss aversion and a normalized difference based on the absolute difference penalty function and the hardware inventory awards to the hardware providers.

8. The system of claim 1, wherein the supply disruption calculation comprises a mean time between catastrophic failure of supply for a corresponding hardware provider.

9. One or more computer storage media having computer-executable instructions embodied thereon that, when executed, by one or more processors, causes the one or more processors to perform a method for generating optimal allocation of hardware inventory procurements, the method comprising:
determining an adjusted total cost based on a plurality of cost assessment-property-metrics, wherein the plurality of cost assessment-property-metrics correspond to hardware providers of a hardware requestor having a hardware inventory procurement;
generating optimal allocation results of the hardware inventory procurement for the hardware providers based on a total addressable market simulation, wherein the total addressable market simulation indicates, based on the adjusted total cost and an exponential probability of loss cost, a total cost of ownership that includes exponential liability assumption of over-allocation; and
communicating the optimal allocation results.

10. The media of claim 9, wherein the adjusted total cost is determined based on at least one cost assessment-property-metric, wherein an assessment-property-metric comprises a classification of an assessment property of a hardware provider, the assessment-property-metric computed based on assessment-property-data.

11. The media of claim 10, wherein the assessment-property-metric is selected from one of: a cost penalty, opportunity cost, hardware inventory cost, supply delay, return merchandise authorization (RMA), RMA delays, and validation delays.

12. The media of claim 10, wherein the assessment-property-data is a classification that represents actions performed in a computing infrastructure based on attributes of the hardware provider.

13. The media of claim 12, wherein the assessment-property data is selected from one of: Original Equipment Manufacturer (OEM) quotes, historical on time request (OTTR), engineering data, and datacenter operations.

14. The media of claim 9, wherein the hardware inventory procurement comprises hardware inventory components, where the hardware providers represent the total addressable market that comprises each of the hardware providers that fulfill the hardware inventory procurement for the hardware requestor.

15. The media of claim 14, wherein the hardware requestor operates a cloud computing infrastructure that comprises a service that facilitates automatically retrieving, storing, processing, and communicating assessment-property-data and computing assessment-property metrics.

16. The media of claim 9, wherein the exponential probability of loss cost is based on a revenue of the hardware inventory for a defined time period, an absolute difference penalty function based on hardware inventory awards to hardware providers, an exponential probability of loss function and a probability of supply disruption.

17. A computer-implemented method for generating optimal allocation of hardware inventory procurements, the method comprising:
accessing optimal allocation results that correspond to hardware providers for a hardware requestor having a hardware inventory procurement, wherein the optimal allocation results are based on a total addressable market simulation, wherein the total address addressable market simulation indicates, based on the adjusted total cost and an exponential probability of loss cost, a total cost of ownership that includes exponential liability assumption of over-allocation; and
communicating the optimal allocation results for display, wherein the display comprises at least two of an optimal allocation indicator, a menu of choices, and a sensitivity graph.

18. The method of claim 17, wherein the optimal allocation results indicate the hardware providers, wherein the hardware providers represent the total addressable market that comprises each of the hardware providers that fulfill a hardware inventory component for the hardware requestor.

19. The method of claim 17, wherein the optimal allocation is indicated using an optimal allocation indicator in a menu of choices, wherein the optimal allocation results are generated in at least one of a graph representation or a tabular representation.

20. The method of claim 17, wherein the tabular representation comprises a total purchase order cost and a total cost of ownership, wherein the total cost of ownership comprises the adjusted total cost and the exponential probability of loss cost, wherein the exponential probability of loss cost is based on a revenue of the hardware inventory for a defined time period, an absolute difference penalty function based on hardware inventory awards to hardware providers, an exponential probability of loss function and a probability of supply disruption.
